(19) United States
(12) Patent Application Publication
(10) Pub. No.: US 2010/0054251 A1
(43) Pub. Date: Mar. 4, 2010

(54) METHOD OF PROCESSING PACKET FOR IMPROVING PERFORMANCE OF ETHERNET SWITCH

(75) Inventors: Won Kyoung LEE, Daejeon-city (KR); Jaewoo PARK, Daejeon-city (KR); Bheom Soon JOO, Daejeon-city (KR)

Correspondence Address: Muncy, Geissler, Olds & Lowe, PLLC, P.O. BOX 1364, FAIRFAX, VA, 22038-1364, US

(73) Assignee: ELECTRONICS AND TELECOMMUNICATIONS RESEARCH INSTITUTE, Daejeon-city (KR)

(21) Appl. No.: 12/423,216

(22) Filed: Apr. 14, 2009

(30) Foreign Application Priority Data
Aug. 28, 2008 (KR) 10-2008-0084752

(51) Int. Cl. H04L 12/56

(52) U.S. Cl. 370/392; 370/395.31

(57) ABSTRACT

Provided is a method of processing a packet for improving performance of an Ethernet switch. According to the present invention, a routine of searching a virtual local area network (VLAN) table by a decapsulation microblock and a bridge microblock may be performed by a core component when a core component generates tables and thus the number of memory accesses may be reduced. Also, VLAN port state information of an input port and VLAN port tagging information of an output port may be stored in metadata and may be transmitted to a next microblock. Accordingly, a duplicate memory access routine of the bridge microblock and an encapsulation microblock may be removed and thus an access time delay may be reduced, thereby improving performance of an Ethernet switch.

### CROSS-REFERENCE TO RELATED PATENT APPLICATION

This application claims the benefit of Korean Patent Application No. 10-2008-0084752, filed on Aug. 28, 2008, in the Korean Intellectual Property Office, the disclosure of which is incorporated herein in its entirety by reference.

### BACKGROUND OF THE INVENTION

1. Field of the Invention

The present invention relates to an Ethernet switch, and more particularly, to a method of processing a packet for improving performance of an Ethernet switch.

The present invention is derived from a research project supported by the Information Technology (IT) Research & Development (R&D) program of the Ministry of Knowledge Economy (MKE) and the Institute for Information Technology Advancement (IITA) [2006-S-061-03, Technology Development of IPv6-based QoS Service and Device Mobility Supporting Router].

2. Description of the Related Art

Conventionally, microblocks processing packets in an ingress and an egress have to access various lookup tables stored in static random access memory (SRAM) in order to obtain information required to perform each operation. In this case, a total time taken to access the SRAM greatly influences the performance of an Ethernet switch. In other words, the larger the number of memory accesses is, the lower packet processing speed the Ethernet switch has.

### SUMMARY OF THE INVENTION

The present invention provides a method of processing a packet for improving performance of an Ethernet switch by reducing the number of memory accesses and reducing an access time delay, and an Ethernet switch using the method.

According to an aspect of the present invention, there is provided a method of processing a packet in an Ethernet switch, which classifies a packet according to a type of the packet and performs a virtual local area network (VLAN) mapping function, the method including reading information required to perform the VLAN mapping function, from a VLAN table; reading port state information from a VLAN port table; and inserting the port state information into.

According to another aspect of the present invention, there is provided a method of processing a packet in an Ethernet switch, which determines an output port by using a destination address of the packet, the method including obtaining first information required to determine the output port from a forwarding database (FDB) table by using a hash table regarding the destination address of the packet;

obtaining port state information from metadata; if the port state information indicates a port forwarding state, obtaining second information required to determine the output port from a virtual local area network (VLAN) port table, based on the first information; and, if the port state information read from the VLAN port table indicates the port forwarding state, setting an output port identification (ID) obtained from the FDB table and tagging information obtained from the VLAN port table, to the metadata.

According to another aspect of the present invention, there is provided a method of processing a packet in an Ethernet switch, which processes a virtual local area network (VLAN) tag according to tagging information of an output port of the packet, the method including obtaining an output port identification (ID) and tagging information from metadata; reading maximum transmission unit (MTU) information from a port table corresponding to an output port; inserting, updating, or removing a tag according to a type of the packet; and, if a size of the packet is smaller than the MTU size, writing an updated header of the packet in memory.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of microblocks for processing an Ethernet packet, and lookup tables accessed by the microblocks;

FIG. 2 is a schematic diagram showing correlations between layer-2 (L2) forwarding tables illustrated in FIG. 1;

FIG. 3 is a flowchart of a method of processing a packet by using a decapsulation unit illustrated in FIG. 1;

FIG. 4 is a flowchart of a method of processing a packet by using a bridge unit illustrated in FIG. 1;

FIG. 5 is a flowchart of a method of processing a packet by using an encapsulation unit illustrated in FIG. 1;

FIG. 6 is a schematic diagram of microblocks for processing an Ethernet packet, and lookup tables accessed by the microblocks, according to an embodiment of the present invention;

FIG. 7 is a flowchart of a method of processing a packet by using a decapsulation unit illustrated in FIG. 6, according to an embodiment of the present invention;

FIG. 8 is a structural diagram of a virtual local area network (VLAN) port table according to an embodiment of the present invention;

FIG. 9 is a flowchart of a method of processing a packet by using a bridge unit illustrated in FIG. 6, according to an embodiment of the present invention;

FIG. 10 is a flowchart of a method of processing a packet by using an encapsulation unit illustrated in FIG. 6, according to an embodiment of the present invention; and

FIG. 11 is a structural diagram of metadata of a packet, which is used when microblocks illustrated in FIG. 6 reduce the number of memory accesses, according to an embodiment of the present invention.

### DETAILED DESCRIPTION OF THE INVENTION

Hereinafter, the present invention will be described in detail by explaining embodiments of the invention with reference to the attached drawings.

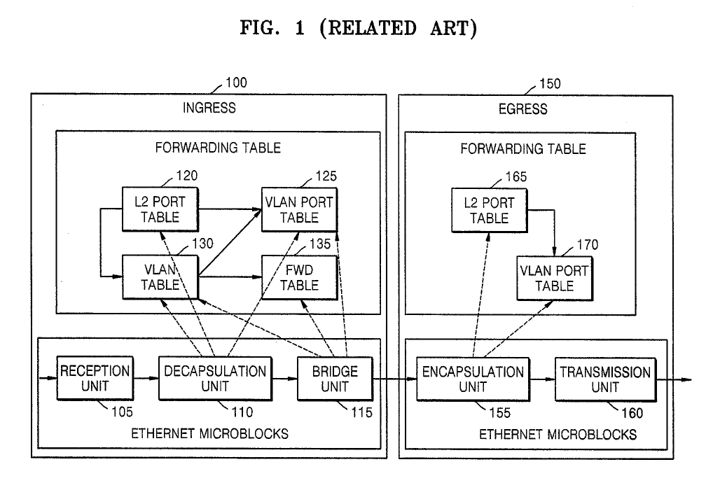

FIG. 1 is a schematic diagram of microblocks for processing an Ethernet packet, and lookup tables accessed by the microblocks.

Referring to FIG. 1, an ingress 100 includes microblocks including a reception unit 105, a decapsulation unit 110, and a bridge unit 115, and an egress 150 includes microblocks including an encapsulation unit 155 and a transmission unit 160.

The decapsulation unit 110 classifies an Ethernet packet based on an Ethernet type so as to map the packet to a virtual local area network (VLAN), the bridge unit 115 searches a forwarding database (FDB) table based on a destination address of the packet so as to determine an output port, and the encapsulation unit 155 processes a VLAN tag based on tagging information of the output port.

The microblocks of the ingress and egress 100 and 150 obtain required information by accessing various layer-2 (L2) forwarding tables stored in a static random access memory (SRAM). For example, the L2 forwarding tables include L2 port tables 120 and 165 which store port information, a VLAN table 130 that stores VLAN IDs, VLAN port tables 125 and 170 which store port IDs included in each VLAN, and an FDB table 135 that is used to search for an output port ID of the packet. In more detail, the ingress 100 includes the L2 port table 120, the VLAN port table 125, the VLAN table 130, and the FDB table 135, and the egress 150 includes the L2 port table 165 and the VLAN port table 170.

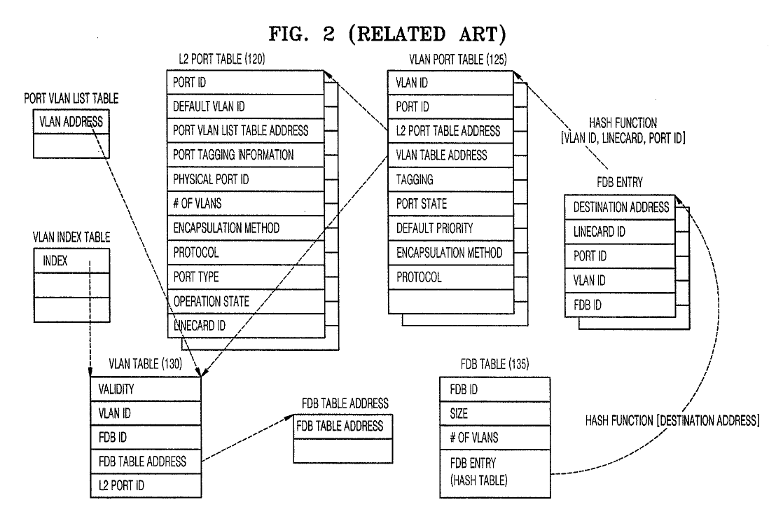

FIG. 2 is a schematic diagram showing correlations between the L2 forwarding tables illustrated in FIG. 1. FIG. 2 will be described in conjunction with FIG. 1.

Referring to FIG. 2, the decapsulation unit 110 searches the L2 port table 120, the VLAN table 130, and the VLAN port table 125. In more detail, the decapsulation unit 110 searches the L2 port table 120 for port tagging information and a default VLAN ID, searches the VLAN table 130 for validity information and an L2 port ID, and searches the VLAN port table 125 for a VLAN table address and port state information. The bridge unit 115 searches the FDB table 135 and the VLAN port table 125. In more detail, the bridge unit 115 searches the VLAN port table 125 for port state information and searches the FDB table 135 for an output port ID.

The L2 port table 120 is indexed with port IDs and the VLAN table 130 is indexed with VLAN IDs. The VLAN port table 125 is indexed with hash keys using VLAN IDs and port IDs and the FDB table 135 is indexed with hash keys using destination addresses.

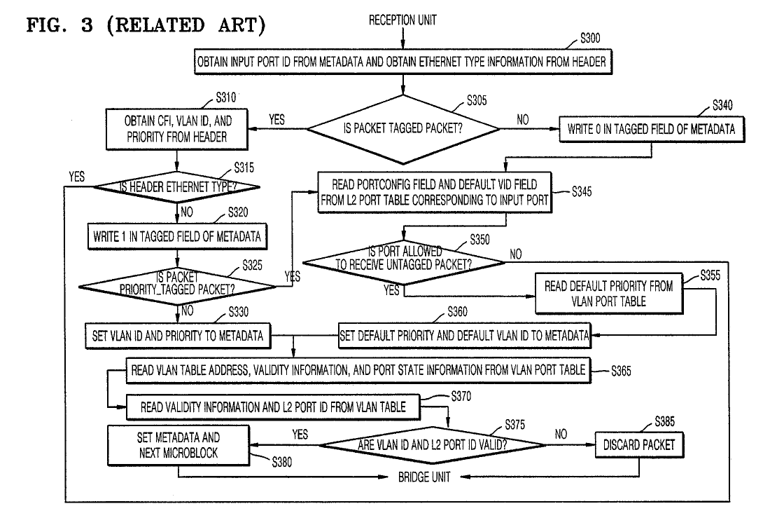

FIG. 3 is a flowchart of a method of processing a packet in the decapsulation unit 110 illustrated in FIG. 1. FIG. 3 will be described in conjunction with FIG. 1.

Referring to FIG. 3, the decapsulation unit 110 receives an Ethernet packet from the reception unit 105, obtains an input port ID from metadata, and obtains Ethernet type information from a header of the packet, in operation S300.

The decapsulation unit 110 checks whether the packet is a tagged packet or an untagged packet, in operation S305.

If it is determined that the packet is the tagged packet in operation S305, the decapsulation unit 110 obtains, for example, a canonical format indicator (CFI), a VLAN ID, and a priority from the header of the packet, in operation S310. If it is determined that the header is not an Ethernet type in operation S315, the decapsulation unit 110 discards the packet, in operation S385. If it is determined that the header is the Ethernet type in operation S315, the decapsulation unit 110 writes a value 1 in a tagged field of the metadata, in operation S320. The decapsulation unit 110 checks whether the packet is a VLAN_tagged packet or a priority_tagged packet, in operation S325. For example, if it is determined that the packet is not the priority_tagged packet in operation S325, the decapsulation unit 110 writes the VLAN ID and the priority in the metadata, in operation S330.

If it is determined that the packet is the untagged packet in operation S305, the decapsulation unit 110 writes a value 0 in the tagged field of the metadata, in operation S340, and reads a default VLAN ID and port tagging information from the L2 port table 120 corresponding to an input port, in operation S345. If receiving of the untagged packet is not allowed in operation S350, the decapsulation unit 110 discards the packet, in operation S385. If the receiving of the untagged packet is allowed in operation S350, the decapsulation unit 110 reads a default priority from the VLAN port table 125 based on the default VLAN ID and the input port ID, in operation S355. Then, the decapsulation unit 110 writes the default priority and the default VLAN ID in the metadata, in operation S360.

After operations are performed according to whether the packet is the tagged packet or the untagged packet as described above, the decapsulation unit 110 performs common operations as described below. The decapsulation unit 110 reads a VLAN table address, validity information, port state information, and the priority from the VLAN port table 125 based on the VLAN ID, a linecard ID, and the input port ID, in operation S365. Also, the decapsulation unit 110 reads the validity information and an L2 port ID from the VLAN port table 125 corresponding to the VLAN table address, in operation S370. If it is determined that the VLAN ID and the L2 port ID are valid in operation S375, the decapsulation unit 110 sets the metadata and a next microblock in operation S380, and then transmits the packet to the bridge unit 115.

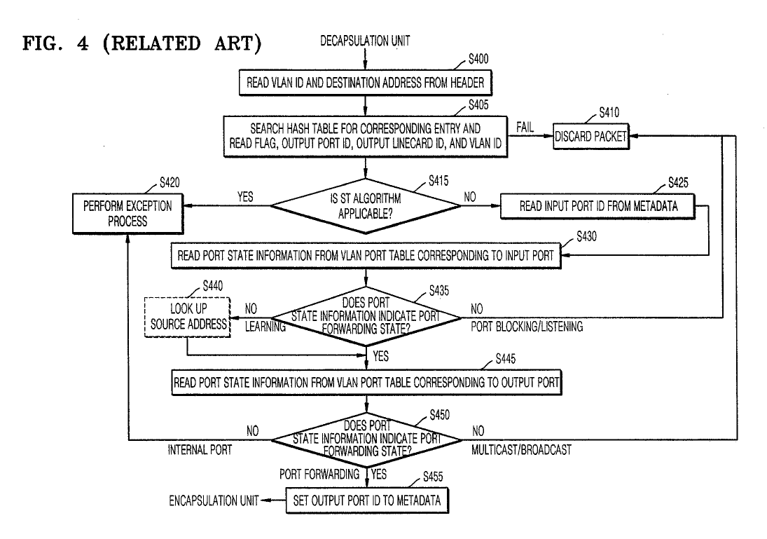

FIG. 4 is a flowchart of a method of processing a packet by using the bridge unit 115 illustrated in FIG. 1. FIG. 4 will be described in conjunction with FIG. 1.

Referring to FIG. 4, the bridge unit 115 receives the packet from the decapsulation unit 110 and then obtains a VLAN ID and a destination address from a header of the packet, in operation S400. The bridge unit 115 searches the FDB table 135 for a corresponding entry and reads a flag and an output port ID, by using the destination address, in operation S405. If it is determined that the flag is set to apply a spanning tree (ST) algorithm in operation S415, the bridge unit 115 performs an exception process in operation S420. If it is determined that the flag is not set to apply the ST algorithm in operation S415, the bridge unit 115 obtains an input port ID from metadata in operation S425. Then, the bridge unit 115 reads port state information from the VLAN port table 125 based on the VLAN ID, a linecard ID, and the input port ID, in operation S430. If the port state information indicates a learning state in operation S435, the bridge unit 115 looks up a source address in operation S440. If the port state information indicates a port blocking state or a listening state in operation S435, the bridge unit 115 discards the packet in operation S410.

Then, the bridge unit 115 reads the port state information from the VLAN port table 125 based on the VLAN ID, the linecard ID, and the output port ID, in operation S445. If the port state information indicates an internal port state in operation S450, the bridge unit 115 performs the exception process in operation S420. If the port state information indicates a multicasting state or a broadcasting state in operation S450, the bridge unit 115 discards the packet in operation S410. If the port state information indicates a port forwarding state in operation S450, the bridge unit 115 sets the output port ID to the metadata in operation S455, and transmits the packet to the encapsulation unit 155 of the egress 150.

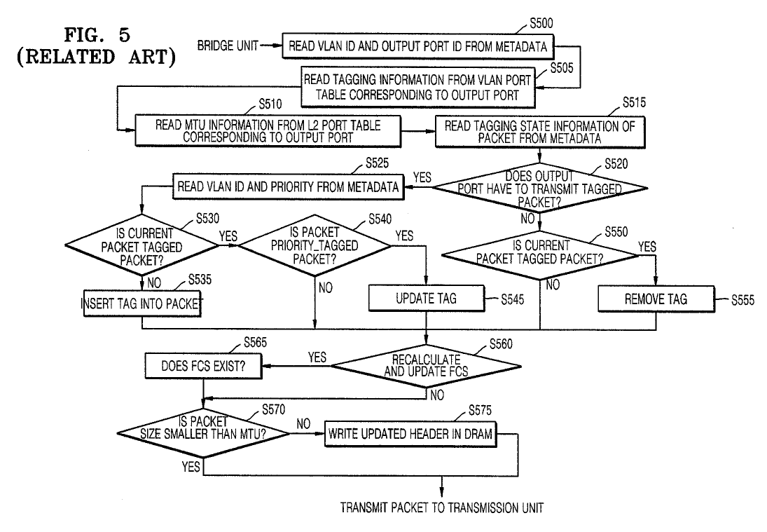

FIG. 5 is a flowchart of a method of processing a packet by using the encapsulation unit 155 illustrated in FIG. 1. FIG. 5 will be described in conjunction with FIG. 1.

Referring to FIG. 5, the encapsulation unit 155 receives the packet from the bridge unit 115, and obtains a VLAN ID and an output port ID from metadata, in operation S500. Then, the encapsulation unit 155 reads tagging information from the VLAN port table 170 based on the VLAN ID, a linecard ID, and the output port ID, in operation S505. Also, the encapsulation unit 155 reads maximum transmission unit (MTU) information from the L2 port table 165 corresponding to an output port, in operation S510. The encapsulation unit 155 obtains tagging state information of the packet from the metadata, in operation S515. The encapsulation unit 155 determines whether to insert a tag into the packet, based on the tagging information of a port, in operation S520. In more detail, the encapsulation unit 155 inserts the tag if the tagging information of the port indicates a value 1, and does not insert the tag if the tagging information of the port does not indicate a value 1.

If the tagging information of the port indicates a value 1, the encapsulation unit 155 obtains the VLAN ID and a priority from the metadata, in operation S525. If the packet is untagged-format in operation S530, the tag is inserted into the packet in operation S535. If the packet is tagged-format in operation S530 and it is determined that the packet is a priority_tagged packet in operation S545, the encapsulation unit 155 updates the tag in operation S545. If the tagging information of the port does not indicate a value 1 in operation S520 and the packet is tagged-format in operation S550, the encapsulation unit 155 removes the tag in operation S555.

Then, if it is determined that a frame check sequence (FCS) exists in operation S560, the encapsulation unit 155 recalculates and updates the FCS in operation S565. If it is determined that a size of the packet is smaller than the MTU size in operation S570, the encapsulation unit 155 writes an updated header in a dynamic random access memory (DRAM) in operation S575, and transmits the packet to the transmission unit 160.

In a structure of the microblocks and the lookup tables which are described above with reference to FIGS. 1 through 5, when a total of 8 gigabytes per second (Gb/s) are input to eight ports at a speed of 1 Gb/s for each port, output speeds were measured under experimental conditions described in Table 1.

TABLE 1

| | |
|---|---|
| Micro Engine | 1.4G |
| Speed | 1.2G |
| # of Micro Engines | 6 Pcs |
| for Processing | 8 Pcs |
| Packet | |
| Packet Type | Tagged Ethernet Frame |
| | Untagged Ethernet |
| | Frame |
| SRAM Maximum | 200 MHz |
| Frequency | |
| TCAM Maximum | 200 MHz |
| Frequency | |
| RDRAM Maximum | 1066 MHz |
| Frequency | |
| Port Speed | 1 Gb/s |
| # of Ports | 8 Pcs |

Experimental results are shown in Table 2.

TABLE 2

| | |
|---|---|
| Six MEs | Eight MEs |

| | Tagged | Untagged | Tagged | Untagged |
|---|---|---|---|---|
| Condition | Frame | Frame | Frame | Frame |
| 1.4G | 6.24 Gb/s | 6.24 Gb/s | 6.20 Gb/s | 6.20 Gb/s |
| 1.2G | 6.04 Gb/s | 6.05 Gb/s | 5.99 Gb/s | 5.97 Gb/s |

As shown in the experimental results given in Table 2, although a micro engine speed increases by 16%, a processing speed increases by only 3%. If the micro engine speed increases, a speed for micro-code execution increases. However, an operation frequency of memory such as a Rambus dynamic random access memory (RDRAM) or SRAM maintains the same or decreases. Thus, it is clear that a speed for the memory access instead of a speed for the micro-code execution influences performance. The processing speed does not vary according to a packet type. That is, tagged and untagged packets have a difference in terms of micro-code execution and do not have a difference in terms of memory access. If the number of micro engines increases, the processing speed decreases.

A conventional packet processing engine has a functional chain structure. Accordingly, if the number of micro engines increases, the number of threads increases and thus the number of packets processed at the same time increases. However, a memory access time delay between threads increases and thus, the performance decreases.

Thus, the memory access time delay has to be reduced by removing an idle time generated during the memory access, in order to improve the performance. For this, codes accessing forwarding tables have to be rearranged so as not to access the forwarding tables at the same time, and the number of memory accesses has to be reduced.

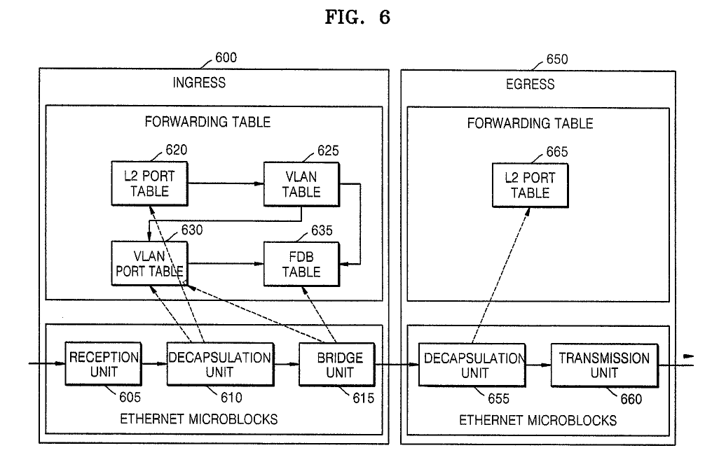

FIG. 6 is a schematic diagram of microblocks for processing an Ethernet packet, and lookup tables accessed by the microblocks, according to an embodiment of the present invention.

Referring to FIG. 6, an ingress 600 includes microblocks including a reception unit 605, a decapsulation unit 610, and a bridge unit 615, and an egress 650 includes microblocks including an encapsulation unit 655 and a transmission unit 660. The ingress 600 includes an L2 port table 620, a VLAN table 625, a VLAN port table 630, and an FDB table 635, and the egress 650 includes an L2 port table 665.

However, a method of accessing the L2 port table 620, the VLAN table 625, the VLAN port table 630, the FDB table 635, and the L2 port table 665 in the reception unit 605, the decapsulation unit 610, the bridge unit 615, the encapsulation unit 655, and the transmission unit 660, which is indicated as dotted arrows, and a reference method between the L2 port table 620, the VLAN table 625, the VLAN port table 630, the FDB table 635, and the L2 port table 665, which is indicated as solid arrows, are different from those shown in FIG. 1.

In more detail, the decapsulation unit 610 and the bridge unit 615 do not include micro codes for searching the VLAN table 625. Although, in FIG. 1, the decapsulation unit 110 includes a micro code for searching the VLAN table 130 in order to check whether a current input port belongs to a current VLAN and has a VLAN membership, such a micro code is removed in FIG. 6.

The checking of the VLAN membership may be sufficiently performed when a core component generates the VLAN table 625 and the VLAN port table 630. Thus, the checking of the VLAN membership of the input port is not implemented as a micro code and is performed when the core component generates the lookup tables.

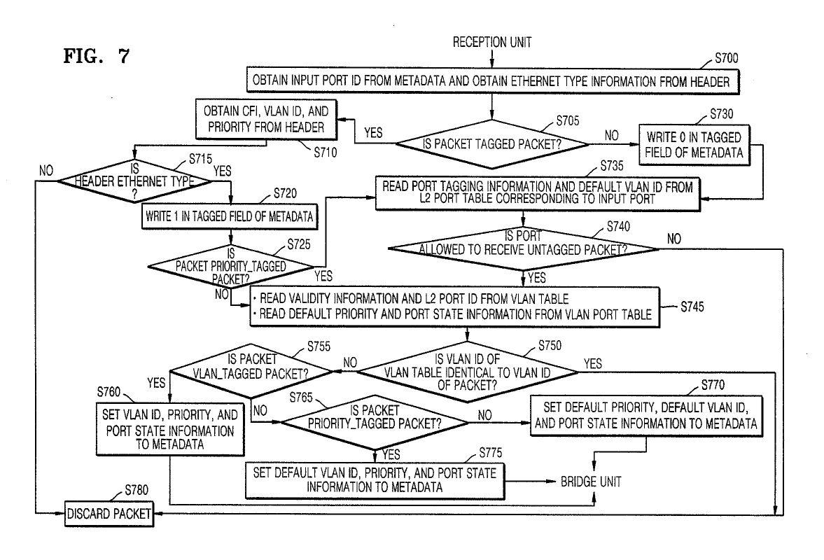

FIG. 7 is a flowchart of a method of processing a packet in the decapsulation unit 610 illustrated in FIG. 6, according to an embodiment of the present invention. FIG. 7 will be described in conjunction with FIG. 6.

Referring to FIG. 7, the decapsulation unit 610 receives an Ethernet packet from the reception unit 605, obtains an input port ID from metadata, and obtains Ethernet type information from a header of the packet, in operation S700.

The decapsulation unit 610 checks whether the packet is a tagged packet or an untagged packet, in operation S705.

If it is determined that the packet is the tagged packet in operation S705, the decapsulation unit 610 obtains, for example, a CFI, a VLAN ID, and a priority from the header of the packet, in operation S710. If it is determined that the header is not an Ethernet type in operation S715, the decapsulation unit 610 discards the packet, in operation S780. If it is determined that the header is the Ethernet type in operation S715, the decapsulation unit 610 writes a value 1 in a tagged field of the metadata, in operation S720. The decapsulation unit 610 checks whether the packet is a VLAN_tagged packet or a priority_tagged packet, in operation S725.

For example, if the VLAN ID indicates a value 0, the packet is the priority_tagged packet.

If it is determined that the packet is the untagged packet in operation S705, the decapsulation unit 610 writes a value 0 in the tagged field of the metadata, in operation S730, and reads a default VLAN ID and port state information from the L2 port table 620 corresponding to an input port, in operation S735. If a current port is set to not allow reception of the untagged packet in operation S740, the decapsulation unit 610 discards the packet, in operation S780.

Then, the decapsulation unit 610 reads validity information and an L2 port ID from the VLAN table 625 corresponding to the VLAN ID, and reads a default priority and the port state information of the VLAN port table 630 from the VLAN table 625, in operation S745.

If the VLAN ID of the VLAN table 625 is identical to the VLAN ID of the packet in operation S750, the decapsulation unit 610 checks the type of the packet in operation S755. If the packet has a VLAN tag (that is, if the packet is the VLAN_tagged packet) in operation S755, the decapsulation unit 610 sets the VLAN ID, the priority, and the port state information to the metadata in operation S760. If the packet does not have the VLAN tag in operation S755, the decapsulation unit 610 checks whether the packet is the priority_tagged packet in operation S765. If it is determined that the packet is the priority_tagged packet in operation S765, the decapsulation unit 610 sets the default VLAN ID, the priority, and the port state information to the metadata in operation S775, and transmits the packet to the bridge unit 615. If the packet is the untagged packet, the decapsulation unit 610 sets the default priority, the default VLAN ID, and the port state information to the metadata in operation S770, and transmits the packet to the bridge unit 615.

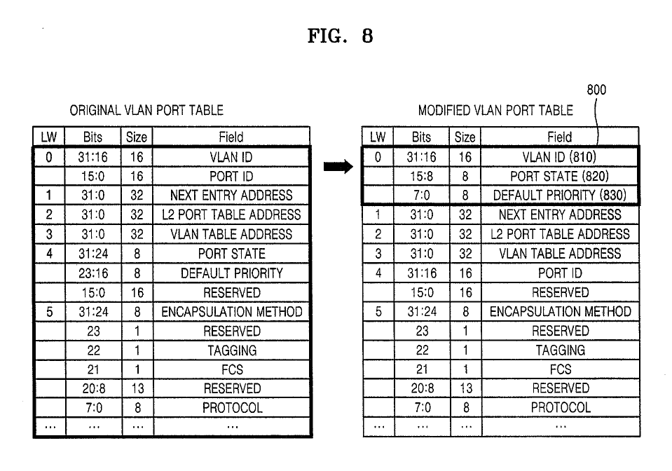

FIG. 8 is a structural diagram of a VLAN port table according to an embodiment of the present invention.

Referring to FIG. 8, information to be read from the VLAN port table includes a VLAN ID 810, port state information 820, and a default priority 830. A reading unit is 1 long word (LW). Thus, the VLAN port table having 5 LW is not wholly read and only 1 LW is read by changing orders of a VLAN ID field, a port state field, and a default priority field and by putting the VLAN ID field, the port state field, and the default priority field into the 1 LW. Accordingly, an unnecessary time delay generated during memory accesses may be reduced. Also, the decapsulation unit 610 illustrated in FIG. 6 may reduce the number of memory accesses from three to two.

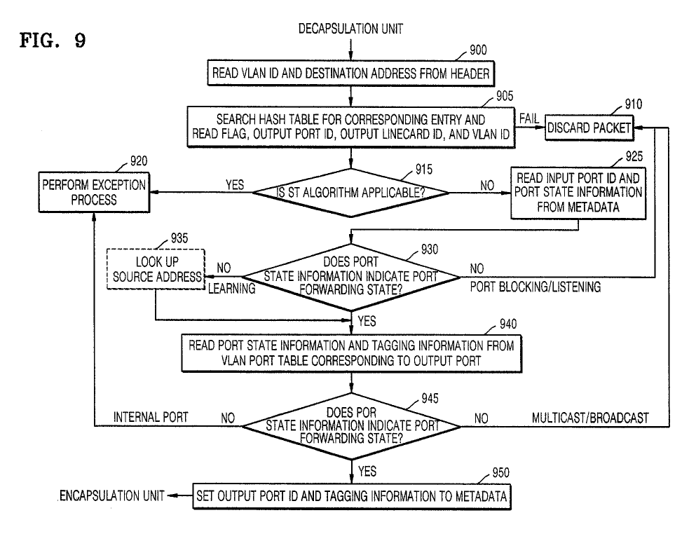

FIG. 9 is a flowchart of a method of processing a packet in the bridge unit 615 illustrated in FIG. 6, according to an embodiment of the present invention. FIG. 9 will be described in conjunction with FIG. 6.

Referring to FIG. 9, the bridge unit 615 receives the packet from the decapsulation unit 610 and then obtains a VLAN ID and a destination address from a header of the packet, in operation S900. The bridge unit 615 searches the FDB table 635 for a corresponding entry and reads a flag and an output port ID, by using the destination address, in operation S905. If it is determined that the flag is set to apply an ST algorithm in operation S915, the bridge unit 615 performs an exception process in operation S920. If it is determined that the flag is not set to apply the ST algorithm in operation S915, the bridge unit 615 obtains an input port ID from metadata in operation S925. Since port state information of the VLAN port table 630 corresponding to an input port is stored in the metadata by the decapsulation unit 610, the bridge unit 615 does not need to access the VLAN port table 630 in order to read the port state information. Thus, the bridge unit 615 may reduce the number of memory accesses from three to two.

In more detail, if the port state information stored in the metadata indicates a learning state in operation S930, the bridge unit 615 looks up a source address in operation S935. If the port state information indicates a port blocking state or a listening state in operation S930, the bridge unit 615 discards the packet in operation S910.

Then, the bridge unit 615 reads the port state information from the VLAN port table 630 based on the VLAN ID, a linecard ID, and the output port ID, in operation S940. If the port state information read from the VLAN port table 630 indicates an internal port state in operation S945, the bridge unit 615 performs the exception process in operation S920. If the port state information indicates a multicasting state or a broadcasting state in operation S945, the bridge unit 615 discards the packet in operation S910. If the port state information indicates a port forwarding state in operation S945, the bridge unit 615 sets the output port ID and tagging information to the metadata in operation S950, and transmits the packet to the encapsulation unit 655 of the egress 650.

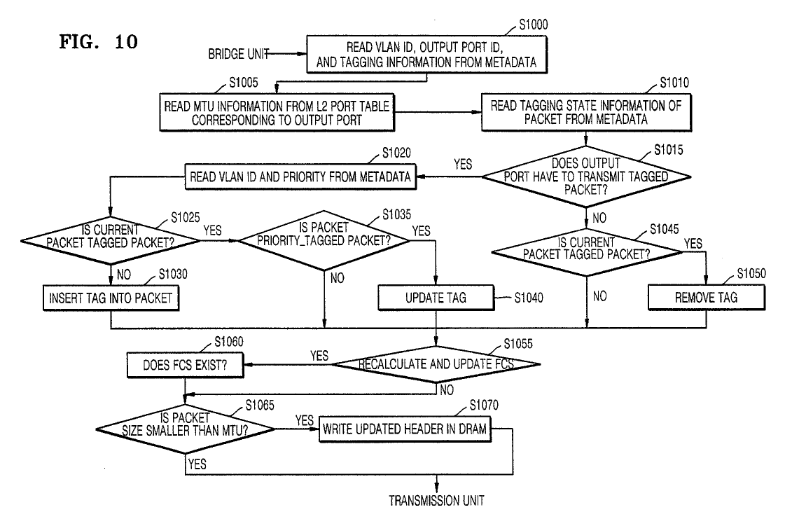

FIG. 10 is a flowchart of a method of processing a packet in the encapsulation unit 655 illustrated in FIG. 6, according to an embodiment of the present invention. FIG. 10 will be described in conjunction with FIG. 6.

Referring to FIG. 10, since the bridge unit 615 stores tagging information of a VLAN port with regard to an output port in metadata, the encapsulation unit 655 does not need to access the VLAN port table 630 for the tagging information. Thus, the encapsulation unit 655 may reduce the number of memory accesses from two to one.

In more detail, the encapsulation unit 655 receives the packet from the bridge unit 615, and obtains a VLAN ID, an output port ID, and the tagging information from metadata, in operation S1000. Then, the encapsulation unit 655 reads MTU information from the L2 port table 665 corresponding to an output port, in operation S1005. The encapsulation unit 655 obtains the tagging information from the metadata, in operation S1010. The encapsulation unit 655 determines whether to insert a tag into the packet, based on the tagging information of a port, in operation S1015. In more detail, the encapsulation unit 655 inserts the tag if the tagging information of the port indicates a value 1, and does not insert the tag if the tagging information of the port does not indicate a value 1.

If the tagging state information of the port indicates a value 1, the encapsulation unit 655 obtains the VLAN ID and a priority from the metadata, in operation S1020. If the packet is untagged-format in operation S1025, the tag is inserted into the packet in operation S1030. If the packet is priority-tagged format in operation S1025 and operation S1035, the encapsulation unit 655 updates the tag in operation S1040. If the tagging state information of the port does not indicate a value 1 in operation S1015 and the packet is tagged-format in operation S1045, the encapsulation unit 655 removes the tag in operation S1050.

Then, if it is determined that an FCS exists in operation S1055, the encapsulation unit 655 recalculates and updates the FCS in operation S1060. If it is determined that the size of the packet is smaller than the MTU size in operation S1065, the encapsulation unit 655 writes a updated header in DRAM in operation S1070, and transmits the packet to the transmission unit 660.

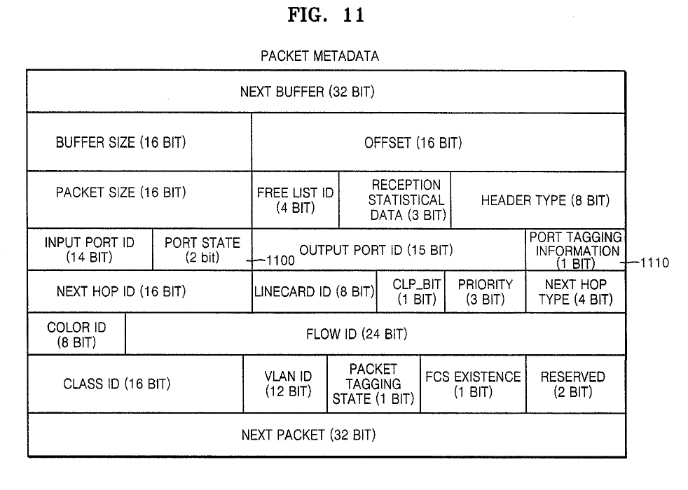

FIG. 11 is a structural diagram of metadata of a packet, which is used when the microblocks illustrated in FIG. 6 reduce the number of memory accesses, according to an embodiment of the present invention.

Referring to FIG. 11, the metadata according to the current embodiment of the present invention includes a port state field 1100 of two bits in an input port field and also includes a port tagging field 1110 of one bit in an output port field.

Thus, a total number of memory accesses for searching forwarding tables is reduced from eight to five and the amount of memory accessed each time is optimized by modifying structures of data and the metadata. Accordingly, a time delay may be minimized.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

According to the present invention, a routine of searching a VLAN table by using a decapsulation microblock and a bridge microblock may be performed when a core component generates tables and thus the number of memory accesses may be reduced. Also, VLAN port state information of an input port and VLAN port tagging information of an output port may be stored in metadata and may be transmitted to a next microblock. Accordingly, a duplicate memory access routine of the bridge microblock and an encapsulation microblock may be removed and thus an access time delay may be reduced, thereby improving performance of an Ethernet switch.

While the present invention has been particularly shown and described with reference to preferred embodiments thereof, it will be understood by one of ordinary skill in the art that various changes in form and details may be made therein without departing from the spirit and scope of the invention as defined by the following claims. The preferred embodiments should be considered in a descriptive sense only and not for purposes of limitation. Therefore, the scope of the invention is defined not by the detailed description of the invention but by the following claims, and all differences within the scope will be construed as being included in the present invention.

What is claimed is:

1 A method of processing a packet in an Ethernet switch, which classifies a packet according to a type of the packet and performs a virtual local area network (VLAN) mapping function, the method comprising:
reading information required to perform the VLAN mapping function, from a VLAN table;
reading port state information from the VLAN port table; and
inserting the port state information into metadata when the metadata is set according to the type of the packet.

2. The method of claim 1, further comprising, if an Ethernet type of the packet is an untagged packet or if a tag of the packet is not a VLAN tag, reading information comprising a default VLAN identification (ID), from a layer-2 (L2) port table corresponding to an input port of the packet, before the information required to perform the VLAN mapping function is read.

3. The method of claim 1, further comprising setting one of a VLAN ID and a default VLAN ID, one of priority and default priority, and the port state information to the metadata according to the type of the packet.

4. The method of claim 1, wherein a VLAN ID field, a port state information field, and a default priority field are sequentially arranged in the VLAN port table.

5. A method of processing a packet in an Ethernet switch, which determines an output port by using a destination address of the packet, the method comprising:
obtaining first information required to determine the output port from a forwarding database (FDB) table by using a hash table regarding the destination address of the packet;
obtaining port state information from metadata;
if the port state information indicates a port forwarding state, obtaining second information required to determine the output port from a virtual local area network (VLAN) port table, based on the first information; and
if the port state information read from the VLAN port table indicates the port forwarding state, setting an output port identification (ID) obtained from the FDB table and tagging information obtained from the VLAN port table, to the metadata.

6. The method of claim 5, wherein the first information comprises a flag, the output port ID, an output linecard ID, and a VLAN ID.

7. The method of claim 5, wherein the second information comprises the port state information and the tagging information.

8. The method of claim 5, wherein the port state information of the metadata is set by a previous microblock.

9. A method of processing a packet in an Ethernet switch, which processes a virtual local area network (VLAN) tag according to tagging information of an output port of the packet, the method comprising:
obtaining an output port identification (ID) and tagging information from metadata;
reading maximum transmission unit (MTU) information from a port table corresponding to an output port;
inserting, updating, or removing a tag according to a type of the packet; and
if a size of the packet is smaller than the MTU size, writing an updated header of the packet in memory.

10. The method of claim 9, wherein the tagging information is set to the metadata by a microblock which determines an output port by using a destination address of the packet.
